(19) United States
(12) Patent Application Publication
(10) Pub. No.: US 2002/0133528 A1
(43) Pub. Date: Sep. 19, 2002

(54) Modem with distributed functionality

(75) Inventors: Ron Aharon Zolti, Ra'anana (IL); Benjamin Maytal, Mavaseret Zion (IL); Gil Koifman, Petach Tigva (IL)

Correspondence Address: LADAS & PARRY, 26 WEST 61ST STREET, NEW YORK, NY, 10023, US

(73) Assignee: SMART LINK LTD.

(21) Appl. No.: 10/093,094

(22) Filed: Mar. 7, 2002

Related U.S. Application Data
(63) Continuation-in-part of application No. 08/929,882, filed on Sep. 15, 1997.
Application No. 08/929,882 is a continuation-in-part of application No. 08/775,385, filed on Dec. 30, 1996, now Pat. No. 6,092,095.

(51) Int. Cl. G06F 9/00

(52) U.S. Cl. 709/100

(57) ABSTRACT

Apparatus for data communications includes at least one modem front end, adapted to receive an incoming communication signal conveying incoming information over a communication medium, and at least one modem host. The front end includes front-end circuitry, which is coupled to receive the signal from the communication media and to process the signal so as to generate a stream of incoming digitized samples, and a local area network (LAN) interface unit, which is coupled to receive the incoming digitized samples and to frame the samples in data frames for transmission over a LAN. The modem host receives the data frames from the LAN and processes the incoming digitized samples so as to extract the information from the signal.

### CROSS-REFERENCE TO RELATED APPLICATION

This application is a continuation-in-part of U.S. Patent Application 08/929,882, filed Sep. 15, 1997, which is assigned to the assignee of the present patent application and whose disclosure is incorporated herein by reference.

### FIELD OF THE INVENTION

The present invention relates generally to modems, and specifically to “soft” modems, in which modem signal processing operations are performed by software on a host computer.

### BACKGROUND OF THE INVENTION

Modems are used for transferring information on communication lines or other communication media between two parties. The modem converts information from electrical signals on the communication line to data bits, and vice versa. In conventional modems, all the signal processing operations involved in extracting the data from incoming communication line signals, as well as generating outgoing signals to send data, are performed by dedicated modem hardware circuits. In soft modems, however, some or all of these signal processing functions are performed by a host processor in a computer that is connected to the line or other media. Soft modems thus take advantage of the computational power of the host and reduce the volume and cost of hardware that is required for communications. Exemplary soft modems are described in U.S. Pat. Nos. 4,965,641 and 6,092,095, which are incorporated herein by reference. Soft modem functions can also be offloaded from the host processor to a programmable digital signal processor (DSP), as described in U.S. Pat. No. 6,298,370, which is also incorporated herein by reference.

Typically, in a soft modem configuration, a hardware analog front end samples and digitizes the incoming communication line signals, so as to generate a stream of digital samples. The digitized sample values are transferred by direct memory access (DMA) to the host memory. The host central processing unit (CPU) then performs physical layer processing, also known as “data pump” functions, on the samples, such as equalization and echo cancellation, in order to extract the data bits from the samples. The CPU also performs low-level protocol layer functions, such as error correction and data compression. For outgoing signals, the host similarly prepares digital values in the memory, which are then read out by DMA and converted to analog signals on the communication line by the front end.

Most soft modems available today are used in personal computers (PCs) for low-speed data communications over telephone lines. The hardware front end is typically installed in the PC and communicates with the memory and the CPU via a fast parallel bus, such as the industry-standard Peripheral Component Interface (PCI) bus. The modem software running on the CPU includes a hardware driver that enables it to control the front-end hardware and sample flow via the bus, typically using registers in the front end that are accessible via the bus. Because the bus timing is tightly controlled and has a maximum specified latency, there are only small timing variations in the sample flow into and out of the memory. The hardware and software elements of the soft modem can thus be synchronized in a straightforward way so as to provide the data pump with a continuous flow of samples, as it requires.

In recent years, a variety of broadband modems have been developed to enable high-speed communication over telephone lines, cable television systems and wireless networks. For example, Digital Subscriber Line (DSL) is a modem technology that enables broadband digital data to be transmitted over twisted-pair wire, which is the type of infrastructure that links most home and small business subscribers to their telephone service providers. DSL modems enable users to access high-speed digital networks, such as ATM and Internet Protocol (IP) networks, without requiring major investments in new infrastructure. A range of DSL standards have been defined, known generically as “xDSL.” The various standards have different data rates and other associated features but share common principles of operation.

Asymmetric DSL (ADSL) service, for example, allows data to be conveyed downstream from a central office to subscribers at a rate up to about 8 Mbit/s, and can transport an upstream signal from the subscribers at a rate of about 640 kbit/s. ADSL is rate-adaptive, and the actual rate of data transmission over each subscriber line is determined in a start-up mode, upon initiation of communications between a subscriber modem and the central office, depending on line conditions and capabilities of the modem. (The use of this sort of adaptive-rate “training” mode is common to most modem standards.) ADSL is based on a discrete multi-tone (DMT) transmission system, in which data are encoded using 256 different “tones,” each corresponding to a frequency band 4.3125 kHz wide. Each DMT symbol is a mapping of a fixed number of bits to sine waves of multiple frequencies. The number of bits per symbol is determined according to the line quality, and is typically low for long and noisy lines. Further aspects of ADSL are defined in Recommendation G.992.1 of the International Telecommunication Union (ITU), which is incorporated herein by reference.

Because of the high-speed processing requirements, most broadband modems available today use dedicated hardware to carry out all the required modem operations. (One exception is ADSL Softmodem software, provided by GAO Research Inc., Toronto, Canada, as described at www.gaoresearch.com. This software is designed to run on a programmable DSP.) Unlike low-speed PC modems, the broadband modem is typically contained in a separate box from the PC, and is connected by a local area network (LAN) to one or more PC clients that it serves. In this configuration, the modem typically comprises an analog front end (AFE), along with several additional dedicated integrated circuit components for performing data pump and data framing protocol operations, as well as an Ethernet adapter for communicating over the LAN. The PC clients must also have Ethernet LAN cards, with a suitable Ethernet software driver, along with communication and application software, as is known in the art.

### SUMMARY OF THE INVENTION

It is an object of some aspects of the present invention to provide a soft modem that does not require tightly-synchronized coupling between the modem's front-end hardware and the host processor that performs the modem's data pump functions.

It is a further object of some aspects of the present invention to provide soft modems that are suited for broadband use.

In preferred embodiments of the present invention, a soft modem system comprises a hardware front end, which is coupled by a LAN to a host processor that performs at least some of the data pump functions of the modem in software. The front end receives an incoming communication signal, and processes the signal to generate a stream of digitized samples. In some preferred embodiments, the signal is received on a broadband wireline connection, although the principles of the present invention are also applicable to other communication media. Optionally, the front-end may comprise digital front-end processing circuits, which perform initial data pump operations on the samples before sending the preprocessed sample values to the host processor. The front end has a LAN interface, which assembles the sample values into frames, in accordance with an appropriate LAN framing protocol, and transmits them to the host processor. The host processor completes the data pump processing of the samples and recovers the data bits from the signal. Outgoing signals are generated in like fashion, with the host processor generating frames of digital sample values, and sending the frames over the LAN to the front-end for transmission as analog signals.

Preferred embodiments of the present invention thus provide broadband modem capabilities, with reduced requirements for costly, dedicated hardware in comparison with broadband modems known in the art. Because the front end and host processor are connected by a LAN, such as an Ethernet LAN, rather than by a high-speed parallel bus, these elements can be located far from one another without adversely affecting modem operation. Provisions are made in the front end and in the host processor software to ensure that errors and exceptions are handled without undue loss of the modem connection, and that the mutual timing of hardware and software operations is properly controlled, despite the asynchronous nature of LAN communications. The LAN-based configuration of the soft modem also means that the hardware resources of the front end can be shared among multiple host processors on the LAN.

There is therefore provided, in accordance with a preferred embodiment of the present invention, apparatus for data communications, including:

at least one modem front end, adapted to receive an incoming communication signal conveying incoming information over a communication medium, and including:

front-end circuitry, which is coupled to receive the signal from the communication medium and to process the signal so as to generate a stream of incoming digitized samples; and

a first local area network (LAN) interface unit, which is coupled to receive the incoming digitized samples and to frame the samples in data frames for transmission over a LAN; and at least one modem host, including:

a second LAN interface unit, which is adapted to receive the data frames from the LAN and to extract the incoming digitized samples therefrom; and

a sample processor, which is coupled to receive the incoming digitized samples from the second LAN interface unit, and to process the samples so as to extract the information from the signal.

In a preferred embodiment, the at least one modem front end includes a plurality of modem front ends, which are coupled to receive signals from respective communication media, and which are coupled to communicate with the at least one modem host over the LAN. Additionally or alternatively, the at least one modem host includes a plurality of modem hosts, which are coupled to communicate with the at least one modem front end over the LAN.

Preferably, the first and second LAN interface units include Ethernet interface units. Typically, the data frames in which the first LAN interface frames the samples are frames of fixed size, and the first LAN interface is adapted to insert a header in each of the frames. Preferably, the header includes a running frame index and a parameter specifying a type of the frame, selected from a group of types consisting of samples, commands and notifications. Most preferably, when the type of the frame is the notification type, the first LAN interface is further adapted to insert at least one parameter in the header, from a group of parameters consisting of a sample counter index, a status response to a command, and an exception notification. Further preferably, the second LAN interface is adapted to send command frames to the first LAN interface unit, each of the command frames including a command header including at least one parameter from a group of parameters consisting of a command type, a sample counter index, and a command code.

In a preferred embodiment, the communication medium includes a telephone subscriber line, and the front-end circuitry is adapted to receive the signal in accordance with an Asymmetric Digital Subscriber Line (ADSL) communication protocol, substantially as defined by standard G992.1 of the International Telecommunications Union.

Preferably, the modem host includes a computer, and wherein the sample processor includes a programmable processing unit of the computer, which is programmed in software to process the samples. Most preferably, the programmable processing unit is further programmed to process the information extracted from the signal using a communication application program.

Preferably, the sample processor is further adapted to operate as a sample generator, which receives outgoing information to be conveyed over the communication medium and processes the outgoing information so as to generate outgoing digital samples, and the second LAN interface unit is adapted to frame and transmit the outgoing digital samples over the LAN to the first LAN interface unit, and the front-end circuitry is coupled to receive and process the outgoing digital samples from the first LAN interface unit so as to generate an outgoing communication signal for transmission over the communication medium.

Further preferably, the front-end circuitry is adapted to generate the outgoing communication signal substantially continuously, notwithstanding a transient disturbance in receiving the outgoing digital samples from the sample processor. Most preferably, the second LAN interface unit is adapted to add an index to the outgoing digital samples transmitted over the LAN indicative of a running count of the samples, and the at least one modem front end is adapted to detect the transient disturbance responsive to the index, and to generate substitute samples for processing so as to compensate for the loss. Typically, the disturbance in the transmission includes a loss of one or more of the data frames or a delay in arrival of one or more of the data frames at the modem front end.

Preferably, the front-end circuitry includes an analog front end, which is coupled to receive and digitize the signal so as to generate raw digital samples, and digital preprocessing circuitry, which is adapted to performing one or more initial processing steps required to extract the information from the signal, whereby the stream of digitized samples conveyed to the sample processor includes preprocessed samples, wherein the sample processor is adapted to perform one or more subsequent processing steps on the preprocessed samples. Typically the one or more initial processing steps include at least one of a time-to-frequency transformation step, so that the preprocessed samples include frequency-domain samples, an equalization step, and an echo cancellation step.

Further preferably, the digital preprocessing circuitry is configurable, under control of the sample processor, to bypass at least one of the initial processing steps, whereupon the sample processor itself performs the at least one of the initial steps that is bypassed. Typically, the incoming communication signal is received via a connection over the communication medium with a remote modem, wherein during an initial phase of the connection, the digital preprocessing circuitry is configured so that the at least one of the initial processing steps is bypassed and performed by the sample processor, and wherein during a subsequent phase of the connection, following the initial phase, the digital preprocessing circuitry is reconfigured so that the at least one of the initial processing steps is no longer bypassed, whereby the digital preprocessing circuitry performs the at least one of the initial processing steps. Preferably, the initial phase includes a training phase, during which parameters of the connection are determined by negotiation between the sample processor and the remote modem, and the parameters are set in the digital preprocessing circuitry during the subsequent phase.

Most preferably, the digital preprocessing circuitry is configurable so that each of the initial processing steps can be activated or deactivated under control of the sample processor. Additionally or alternatively, the sample processor is adapted to control the digital preprocessing circuitry so as to activate the initial processing steps in sequence.

Preferably, the front-end circuitry includes a local oscillator, which is adapted to generate a sampling clock for use in sampling the signal so as to generate the digitized samples, and the sample processor is adapted, responsive to the incoming digitized samples, to determine a desired frequency of the sampling clock, and the second LAN interface unit is adapted to send a command frame to the first LAN interface unit indicating the desired frequency determined by the sample processor, causing the front-end circuitry to adjust the local oscillator responsive to the desired frequency.

Typically, the local oscillator is configured to generate the sampling clock at a set of discrete operating frequencies, and the front-end circuitry includes an oscillator controller, which is adapted to control the local oscillator so as to select the operating frequencies, and when the desired frequency is between two of the discrete operating frequencies, the oscillator controller controls the local oscillator so that it generates the sampling clock at the two of the discrete operating frequencies in respective, alternating time intervals. Preferably, the alternating time intervals have durations selected so that an average operating frequency of the sampling clock over the intervals is approximately equal to the desired frequency.

Preferably, the first LAN interface unit is adapted to add an index to each of the data frames indicative of a running count of the samples transmitted over the LAN, and the sample processor is adapted to synchronize its operation with that of the modem front end responsive to the index. Most preferably, the sample processor is adapted to detect a disturbance in transmission of the data frames responsive to the index, and to generate substitute samples for processing so as to compensate for the disturbance, wherein the disturbance in the transmission includes a loss of one or more of the data frames or a delay in arrival of one or more of the data frames at the sample processor.

Additionally or alternatively, the sample processor is adapted to generate a command to alter an operating parameter of the front-end circuitry at a point in time corresponding to a predetermined value of the running count of the samples, and the second LAN interface unit is adapted to send a command frame to the first LAN interface unit containing the command, which causes the front-end circuitry to alter the operating parameter when the running count reaches the predetermined value.

There is also provided, in accordance with a preferred embodiment of the present invention, apparatus for data communications, including:

a modem host, including:

a sample generator, which is adapted to receive information for transmission over a communication medium and to generate, responsive to the information, a stream of outgoing digital sample values;

a first local area network (LAN) interface unit, which is coupled to receive the outgoing digital sample values and to frame the values in data frames for transmission over a LAN; and a modem front end, including:

a second LAN interface unit, which is adapted to receive the data frames from the LAN and to extract the outgoing digital sample values therefrom; and

front-end circuitry, which is coupled to receive the outgoing digital sample values and to process the values so as to generate an outgoing signal for transmission over the public communication network.

There is additionally provided, in accordance with a preferred embodiment of the present invention, a method for data communications, including:

receiving an incoming communication signal conveying incoming information over a communication medium;

sampling and processing the incoming signal so as to generate a stream of incoming digitized samples;

framing the incoming digitized samples in data frames for transmission over a local area network (LAN);

transmitting the data frames over the LAN to a processing unit;

extracting the samples from the frames at the processing unit;

processing the samples, using the processing unit, so as to extract the information from the signal.

There is further provided, in accordance with a preferred embodiment of the present invention, a method for data communications, including:

receiving outgoing information for transmission over a communication medium;

generating, responsive to the information, a stream of outgoing digital sample values;

framing the outgoing digital sample values in data frames for transmission over a local area network (LAN);

transmitting the data frames over the LAN to a modem front end;

extracting the sample values from the frames at the modem front end;

processing the sample values at the modem front end so as to generate an outgoing signal for transmission over the public communication network.

There is moreover provided, in accordance with a preferred embodiment of the present invention a front end unit for a modem, including:

front-end circuitry, which is adapted to receive an incoming communication signal conveying incoming information over a communication medium, and to process the signal so as to generate a stream of incoming digitized samples; and

a local area network (LAN) interface unit, which is coupled to receive the incoming digitized samples and to frame the samples in incoming data frames for transmission over a LAN to a modem host for processing of the samples so as to extract the information from the signal.

Preferably, the LAN interface unit is further adapted to receive outgoing data frames transmitted over the LAN by the modem host, the outgoing data frames containing outgoing digital samples, and the front-end circuitry is adapted to receive and process the outgoing digital samples from the LAN interface unit so as to generate an outgoing communication signal for transmission over the communication medium.

There is furthermore provided, in accordance with a preferred embodiment of the present invention, a computer software product, including a computer-readable medium in which program instructions are stored, which instructions, when read by a computer, cause the computer to receive data frames from a LAN, the data frames containing incoming digitized samples generated by a modem front end responsive to an incoming communication signal conveying incoming information received by the modem front end over a communication channel, and further cause the computer to extract the incoming digitized samples from the data frames, and to process the samples so as to extract the information from the signal.

The present invention will be more fully understood from the following detailed description of the preferred embodiments thereof, taken together with the drawings in which:

### BRIEF DESCRIPTION OF THE DRAWINGS

FIG. 1A is a block diagram that schematically illustrates a system for data communications using a soft modem, in accordance with a preferred embodiment of the present invention;

FIG. 1B is a block diagram that schematically illustrates a data communication system based on soft modems having multiple front ends and multiple host processors, in accordance with another preferred embodiment of the present invention;

FIG. 2 is a block diagram that schematically illustrates processing of incoming signals received by a soft ADSL modem from a communication line, in accordance with a preferred embodiment of the present invention;

FIG. 3 is a block diagram that schematically illustrates processing of outgoing signals generated by a soft ADSL modem for transmission over a communication line, in accordance with a preferred embodiment of the present invention;

FIG. 4 is a block diagram that schematically illustrates front-end circuitry used in conjunction with a soft ADSL modem, in accordance with a preferred embodiment of the present invention;

FIG. 5 is a block diagram that schematically illustrates software elements associated with a soft modem, in accordance with a preferred embodiment of the present invention;

FIGS. 6A and 6B are timing diagrams that schematically illustrate sequences of data packets sent between a front end and a host processor in a soft modem system, in accordance with a preferred embodiment of the present invention; and

FIG. 7 is a timing diagram that schematically illustrates a method for software control of modem timing, in accordance with a preferred embodiment of the present invention.

### DETAILED DESCRIPTION OF PREFERRED EMBODIMENTS

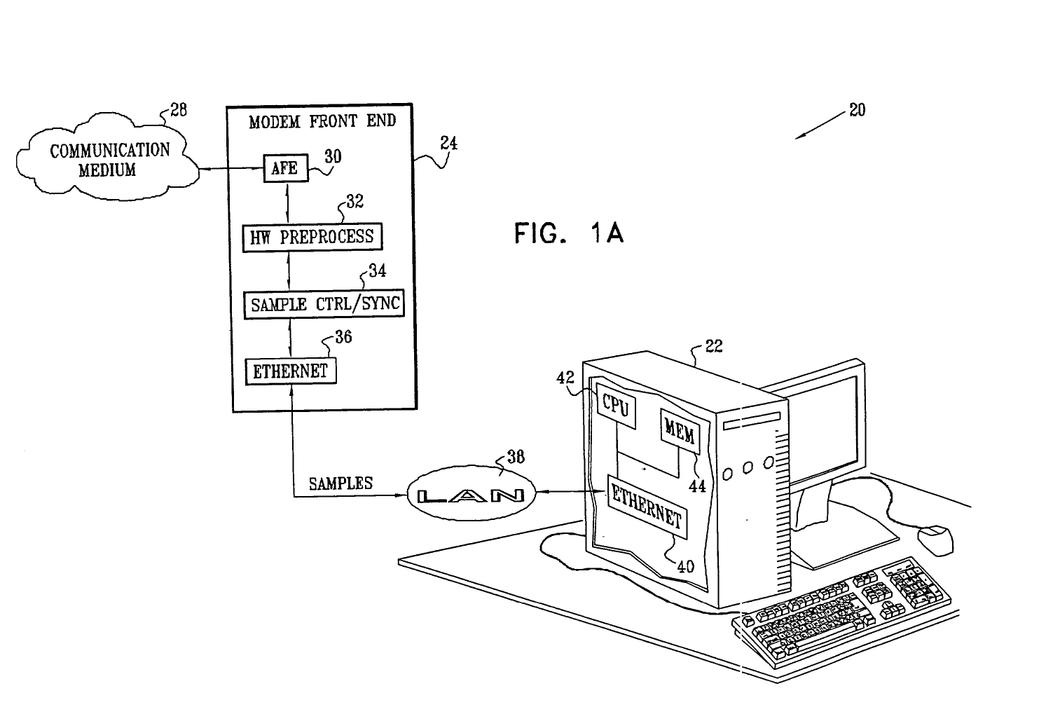

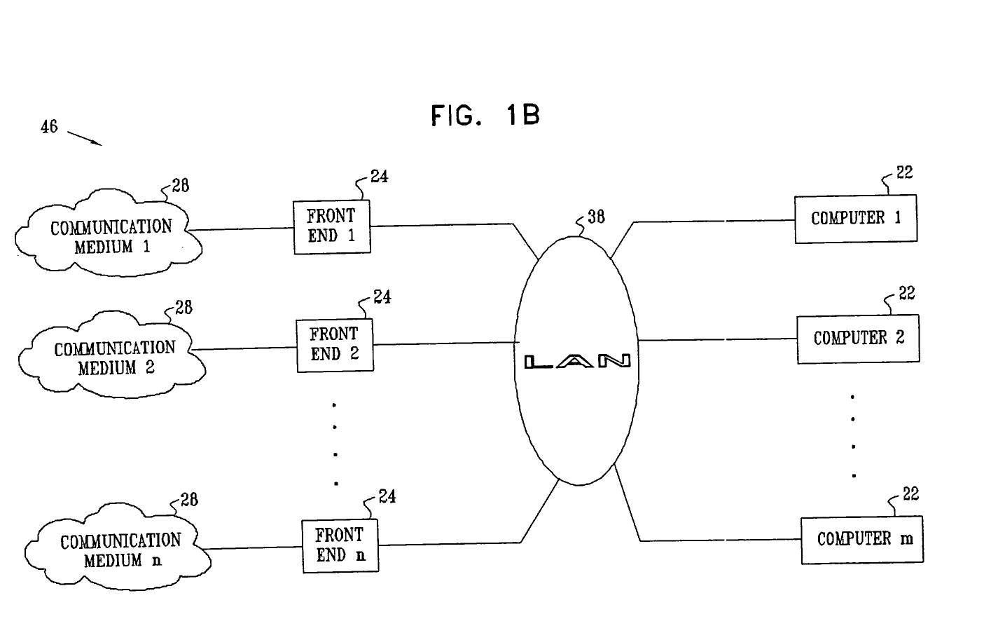

FIG. 1A is a block diagram that schematically illustrates a data communication system 20 based on soft modem operation, in accordance with a preferred embodiment of the present invention. The modem functionality is divided between software running on a host computer 22 and a hardware-based front-end unit 24. The front-end unit is coupled to send and receive signals over a communication medium 28. In the embodiment described hereinbelow, medium 28 comprises a telephone subscriber line, to which front-end unit 24 is connected to communicate with a central office or head-end modem (not shown). In this preferred embodiment, the front-end unit and host software are configured for ADSL operation, as described above, or for another of the xDSL standards. Alternatively, medium 28 may comprise a television cable, a wireless medium, or substantially any other type of network for data communications known in the art. Further alternatively or additionally, the soft modem configuration shown in FIG. 1 may be used, mutatis mutandis, in the central office, as well.

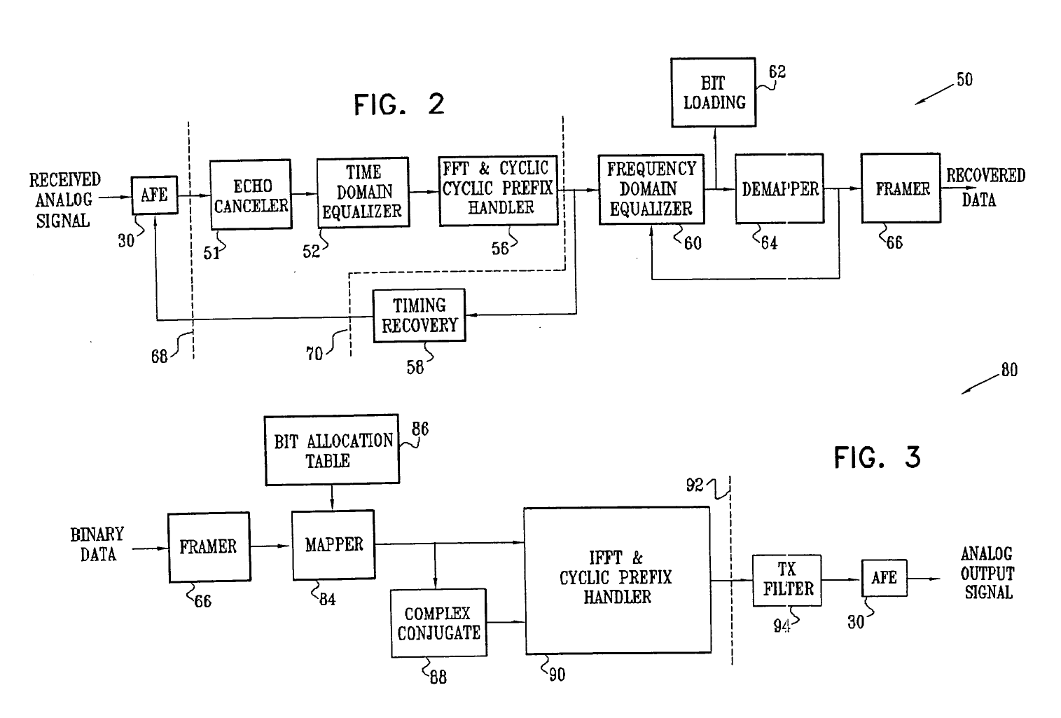

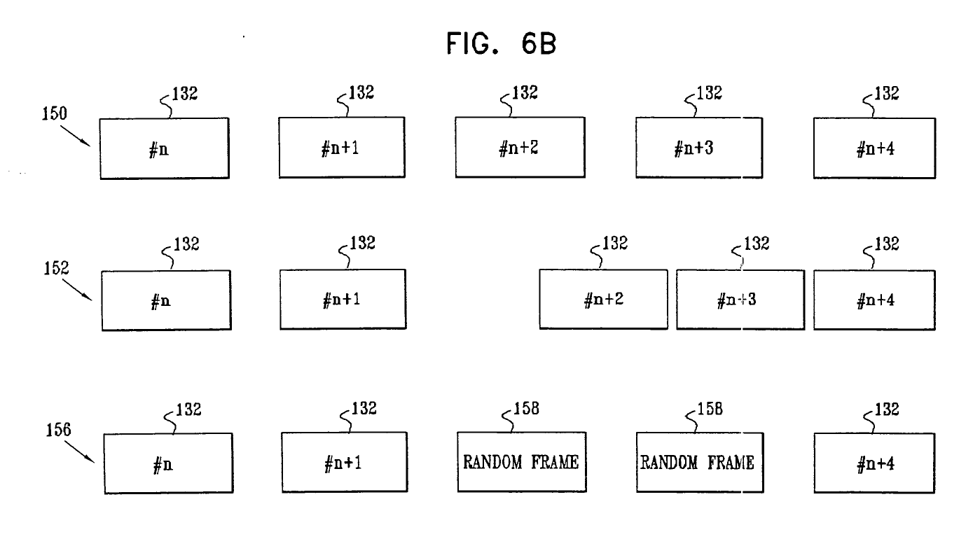

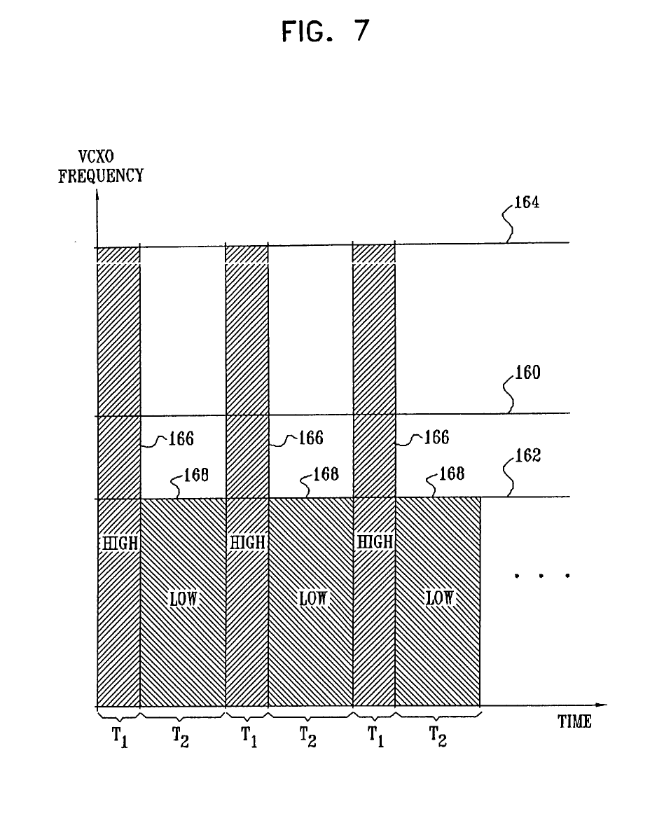

Signals from medium 28 are received, filtered and digitized by an analog front end (AFE) 30, as is known in the art. AFE 30 generates a stream of raw digital samples, which may be further processed in hardware by a digital preprocessing circuit 32. These further processing functions typically comprise the initial stages in the data pump operations that are required to extract data bits from the incoming signals, as described in detail hereinbelow with reference to FIG. 2. A sample control and synchronization circuit 34 performs additional control functions that are needed for soft modem operation in conjunction with host computer 22. These control functions include adjusting the timing of AFE 30, keeping a count of samples for synchronization with the host computer, and exception handling and recovery. These functions are also described in greater detail hereinbelow, particularly with reference to FIGS. 6 and 7.

The digital sample values generated by preprocessing circuit 32 are assembled into Ethernet frames by an Ethernet interface unit 36, for transmission over a LAN 38. The frames include both a conventional Ethernet media access control (MAC) header, for routing of the frames over the LAN to computer 22, and a special command header relating to soft modem functions. For frames that carry digital sample values, the command header contains a packet count value, which is used to monitor the sample stream at the receiving end and ensure that the stream is continuous, without missed frames. (Data correctness within the frame is guaranteed by the MAC unit).

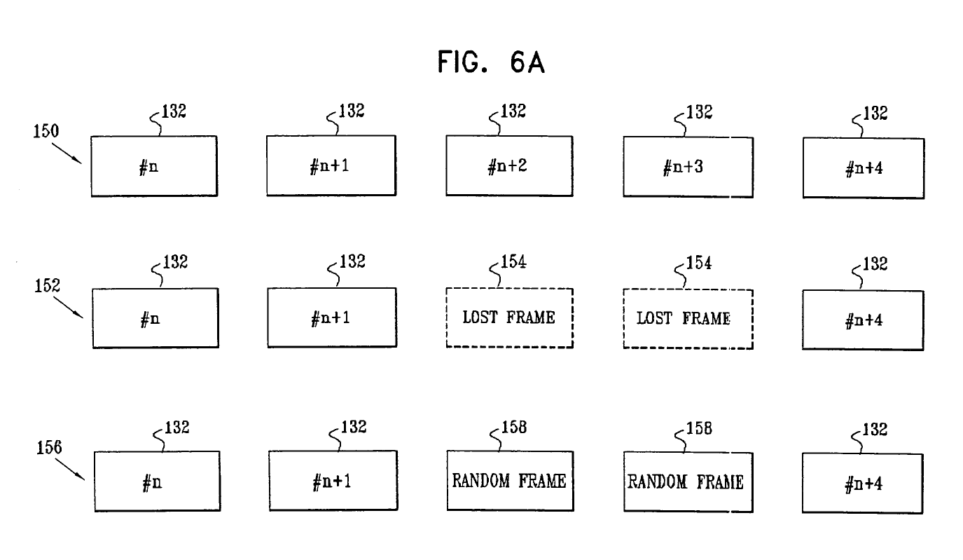

Host computer 22 is coupled to LAN 38 by an Ethernet adapter card 40, as is known in the art. Card 40 receives the frames transmitted by interface unit 36 and passes the frame contents to a random-access memory (RAM) 44 of the host computer. A CPU 42 acts as a sample processor, to process the samples sent by front-end unit 24. Modem software running on the CPU accesses the frame contents in memory 44, in order to read out the sample values and perform the remaining data pump operations needed to extract the data from the sample stream. The data are then available to be used by communication software and other applications running on computer 22. CPU 42 typically comprises a general-purpose microprocessor, such as an Intel Pentium™ device. Alternatively, some or all of the soft modem functions of the CPU, particularly the data pump functions, may be offloaded to a programmable DSP, as described in the above-mentioned U.S. Pat. No. 6,298,370. The structure of the software used to perform the soft modem functions of host computer 22 is described in greater detail hereinbelow with reference to FIG. 5. This software may be downloaded to the host computer in electronic form, over LAN 38, for example, or it may alternatively be furnished on tangible media, such as CD-ROM.

To transmit data over medium 28, CPU 42 acts as a sample generator, performing data pump operations to convert the input data bits (provided by upper-layer applications and protocols) to digital sample values in memory 44. Ethernet card 40 then sends the values in Ethernet frames over LAN 38 to interface unit 36. Preprocessing circuit 32 may perform final data pump operations on the sample values. It then passes the stream of digital values to AFE 30, which converts them to analog signal levels for transmission over medium 28.

FIG. 1B is a block diagram that schematically illustrates a system 46 for data communications, in accordance with an alternative embodiment of the present invention. Although for the sake of simplicity, only a single host computer 22 and front-end unit 24 are shown in FIG. 1A, in practice there may be multiple hosts sharing multiple front-end units over LAN 38, as shown in FIG. 1B. Multi-host and multi-front-end configurations of this sort are shown in the above-mentioned U.S. patent application Ser. No. 08/929,882. This configuration is particularly useful when multiple modems are needed to serve heavy communications traffic. It may thus be used, for example, in the central office of a communication service provider.

In system 46, the front-end unit can be considered a sort of soft modem server, differing from modem servers known in the art in that its input and output are digital samples, rather than fully-processed digital data. The front-end unit may, in fact, have its own CPU, memory and other elements required to perform these server functions (not shown in the figures), whether it serves a single host computer or multiple hosts. In multi-front-end configurations there may be multiple front-end units connected to respective communication media 28, wherein the “back-end” processing is performed by one or multiple host processors.

FIG. 2 is a block diagram that schematically illustrates an input sequence 50 of data pump operations used in processing signals received by system 20 from medium 28, in accordance with a preferred embodiment of the present invention. The elements of sequence 50 are an example of a system for processing DMT signals sent by an ADSL modem, compliant with the ITU G.992.1 standard. Because these individual elements are well known in the art, their internal workings will not be described here. Modifications required to sequence 50 to accommodate other types of communication systems and standards will be apparent to those skilled in the art. Although aspects of the present invention are described here with reference to examples based on ADSL, the principles of the present invention may equally be applied to these different systems and standards.

The input analog signal is filtered and digitized by AFE 30 to generate a stream of digital samples. An echo canceler 51 cancels echoes that may arise due to previously-transmitted signals. A time domain equalizer 52, typically a multi-tap digital filter, equalizes the sample values. A transform processing block 56 removes the cyclic prefixes that are used to delineate the blocks and performs a Fast Fourier Transform (FFT), which converts the remaining stream of samples to the frequency domain for further processing. The frequency-domain samples are used by a timing recovery block 58 to determine whether AFE 30 is optimally synchronized with the symbol clock of the input signal. If block 58 detects a timing error, it signals AFE 30 to adjust its sampling clock accordingly.

The frequency-domain samples output by FFT block 56 are further adjusted by a frequency-domain equalizer 60. The arrays of adjusted samples that are output by equalizer 60 correspond to ADSL DMT symbols. A bit loading block 62 indicates the symbol constellation, i.e., the number of bits per tone (or subchannel) and the relative gain of each tone in the incoming signal. A demapper 64 converts the symbols into a stream of data bits. A framer 66 receives the raw bits from the demapper and performs additional operations to significantly reduce the error rate in the recovered data.

Two dividing lines 68 and 70 in FIG. 2 show the preferred division of data pump operations between hardware preprocessing circuit 32 and software processes on CPU 42. At the starts of the training phase of system 20, upon initiation of communications over medium 28 or when a change occurs in line conditions substantially, all the data pump functions are performed by CPU 42, as indicated by dividing line 68. During this phase, high CPU power consumption by soft modem functions is allowed for the sake of successful completion of the training protocol and setting of operation parameters. Blocks 51, 52, and 56 of circuit 32 are therefore bypassed, and CPU 42 receives the “raw” digitized samples from AFE 30. The CPU processes the sample values in order to communicate with the central office modem to set the communication speed, and to determine equalization coefficients to be applied by time-domain equalizer 52.

As the training phase proceeds, blocks 52, 51 and 56 of circuit 32 are activated, either all at once or gradually, one by one. By the end of the training phase, all these functions are preferably taken over by the front-end hardware, as indicated by dividing line 70. The handover of functions from CPU 42 to circuit 32 is performed by transferring state parameters (such as equalizer coefficients) from CPU 42 to front-end unit 24, and then activating the blocks of the front-end unit at the correct sample count, as described below. The handover must be performed smoothly, without interrupting communications between front-end unit 24 and the central office modem. Such an interruption could lead to an undesired disconnection or return to the training phase. Once the handover has been accomplished, the digital sample values transmitted by the front-end unit over LAN 38 are frequency-domain sample values, rather than raw time-domain samples as previously. This configuration allows the soft modem system to operate without consuming too much of the computational resources of the CPU during the normal data communication phase.

Although dividing lines 68 and 70 show a certain preferred division of functions between front-end unit 24 and CPU 42, alternative divisions may be used, so that unit 24 assumes a larger or smaller share of the data pump operations. Furthermore, although in the embodiment described above, the blocks of the front-end unit that fall between the dividing lines are activated on an “all-or-nothing” basis, it is also possible to activate these blocks individually, while the remaining functions are performed by the CPU.

Preferably, CPU 42 continues to carry out the function of timing recovery block 58 during the normal communication phase, based on the frequency-domain samples that it receives. To correct timing deviations, the CPU sends timing commands in Ethernet frames over LAN 38 to front-end unit 24. Control and synchronization circuit 34 receives these commands and issues control signals accordingly to a local oscillator that generates the sampling clock used by AFE 30. This timing control mechanism is described in detail hereinbelow with reference to FIG. 7.

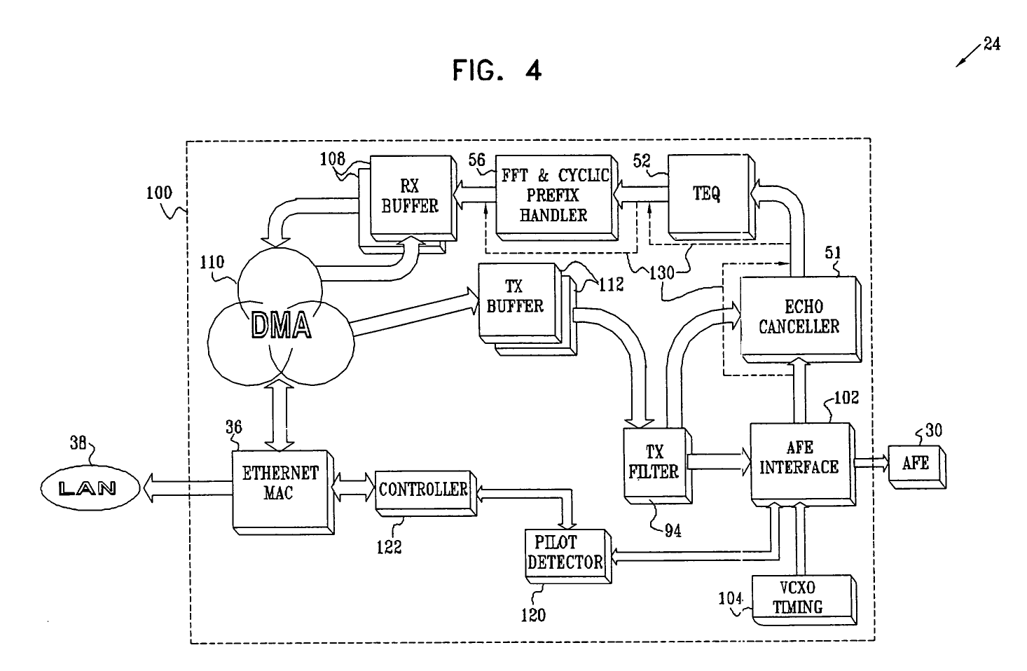

FIG. 3 is a block diagram that schematically illustrates an output sequence 80 of data pump operations used in generating outgoing signals for transmission over medium 28, in accordance with a preferred embodiment of the present invention. Sequence 80 begins with binary input data, which is typically generated by a communication application or protocol running on computer 22. Framer 66 adds error-correcting codes to the bit stream. A mapping block 84 maps the bits to frequency-domain samples, based on symbol constellations provided by a bit allocation table 86. A conjugating block 88 calculates the complex conjugates of the samples generated by mapping block 84. The frequency-domain samples and their complex conjugate samples are input to an inverse FFT (IFFT) block 90, which converts them to time-domain samples and adds cyclic prefixes and synchronization signals, as provided by the ADSL standard.

Up through this point, all the data pump operations are preferably performed by CPU 42, as indicated by a dividing line 92. The Ethernet frames sent by computer 22 over LAN 38 thus contain sequences of time-domain samples, which are then passed to a transmit filter 94 for spectral shaping, and from there to AFE 30 for output as analog signals. Unlike input sequence 50, there is preferably no transfer of modem operations from CPU 42 to front-end unit 24 in output sequence 80 following the initial training phase of system 20. Alternatively, during the normal operation phase of the modem, some of the functions, such as those of block 90, may be performed by hardware preprocessing circuit 32.

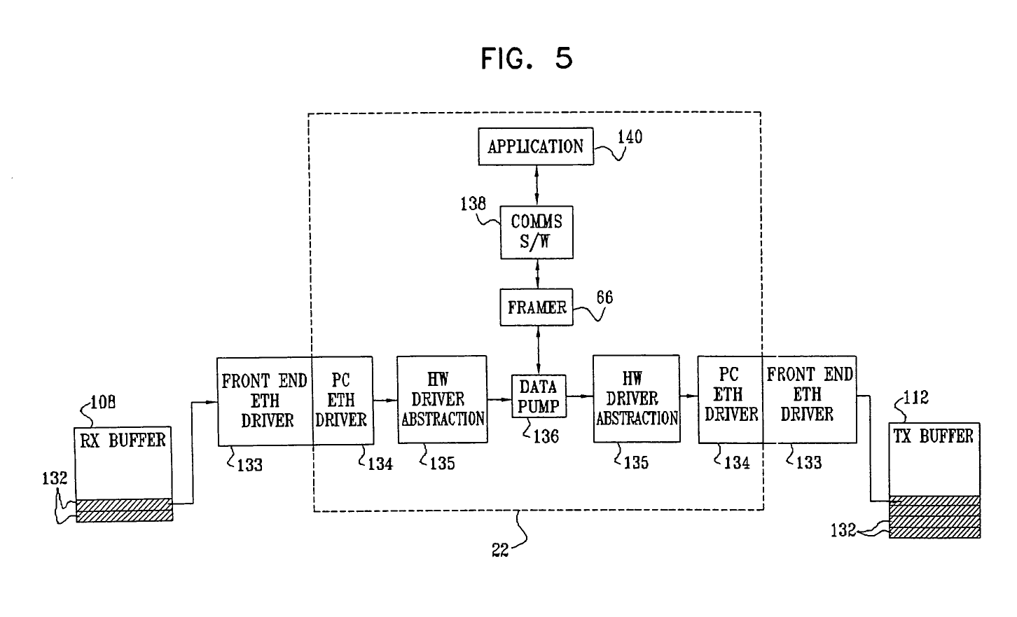

FIG. 4 is a block diagram that schematically shows details of front-end unit 24, in accordance with a preferred embodiment of the present invention. In this embodiment, unit 24 is built around an application-specific integrated circuit (ASIC) 100, which performs the functions of preprocessing circuit 32, control and synchronization circuit 34 and Ethernet interface unit 36. The functions of circuits 32 and 34, while conceptually distinguished one from the other in FIG. 1A, are mixed together among the blocks of ASIC 100. AFE 30 is typically a separate integrated circuit element, such as the Texas Instruments model T1000D600 AFE. Alternatively, other hardware configurations may be used, based on custom or off-shelf integrated circuit components.

An AFE interface block 102 sends digital output sample values to AFE 30, and receives input sample values from the AFE. In addition, block 102 accesses AFE registers in order to control functions of the AFE, such as sample timing. The sampling clock of the AFE is typically generated by a local oscillator, such as a voltage-controlled crystal oscillator (VCXO). A VCXO timing block 104 in ASIC 100 receives timing commands from CPU 42 via LAN 38, and generates timing correction values to be written by the AFE interface block to the AFE. This mechanism is described in greater detail hereinbelow with reference to FIG. 7.

When AFE interface block 102 receives input samples from AFE 30, it passes them to echo cancellation block 51, for removal of echoes that may arise due to previously-transmitted signals. Time-domain equalizer 52 performs equalization of the samples, and passes the filtered samples to FFT and cyclic prefix handling block 56. Bypass lines 130 are provided to allow blocks 51, 52 and 56 to be circumvented during the initial training phase, in which the functions of these blocks are instead performed by CPU 42, as described above. The frequency- or time-domain samples are then stored in receive buffers 108, to await transmission on LAN 38. Preferably, dual buffers are used, so that one buffer can be filled with new samples, while the other buffer is read out for transmission. A DMA engine 110 transfers the data to Ethernet interface unit 36, typically in blocks corresponding to the maximum size of an Ethernet frame. Unit 36 adds the appropriate headers, as described above, and transmits the frames to computer 22 over LAN 38.

When Ethernet interface unit 36 receives a frame of samples from LAN 38, it passes the sample values via DMA engine 110 to one of transmit buffers 112. The samples are then passed via transmit filter 94 to AFE interface 102. The transmit filter allows for sampling rate conversions in the transmitted signal and is also used for control of the power spectral shaping, as noted above.

A controller 122 handles exceptions and exchanges operational commands with CPU 42. When Ethernet interface unit 36 receives a frame that contains a command from CPU 42, it passes the command to controller 122. Outgoing notifications and acknowledgments are similarly sent by controller 122 to the Ethernet interface unit. These notifications and acknowledgments enable CPU 42 to monitor hardware structures of ASIC 100, such as timing block 104 and bypasses 130. In a conventional soft modem, which is located in computer 22 and linked to the CPU by a PCI bus, the CPU would access these hardware functions by reading and writing to registers of the modem, using a hardware driver program running on computer 22. In the configuration of system 20, however, this model of interaction is not possible. Instead, in computer 22 an abstract hardware driver controls the registers of ASIC 100 (possibly at the initiative of the data pump process running on the CPU).

When CPU 42 invokes one of the functions of the abstract hardware driver, the driver generates a command to controller 122 of ASIC 100, which is passed to controller 122 over LAN 38. Controller 122 then carries out the command by making the required adjustments on ASIC 100 or writing to registers of AFE 30. Register values and events are reported from controller 122 to CPU 42 in like fashion. Commands, requests and notifications sent between controller 122 and CPU 42 are carried over LAN 38 by Ethernet frames. To distinguish these control messages from frames carrying modem samples, each frame preferably comprises a header that specifies its type, as well as a running frame index and additional control parameters. For example, when the frame contains a command from CPU 42 to controller 122, the header preferably comprises a sample counter index, identifying the point in the sample stream to which the command pertains, and a field indicating the command type and/or a command code. (The use of the sample counter index is described in greater detail hereinbelow.) Similarly, when the frame contains a notification from controller 122 to CPU 42, the header preferably contains the sample counter index, as well as a field indicating whether the frame contains a status response to a command sent by the CPU or a notification of an exception.

ASIC 100 has additional capabilities required for power saving mode operations when there is no signal on medium 28. When communications resume, a pilot detector 120 detects the pilot tone in the ADSL DMT signals received by AFE 30, and notifies controller 122, which then “wakes up” the modem.

It is important for proper operation of system 20 that front-end unit 24 and CPU 42 maintain mutual synchronization, not in terms of real time, but rather in terms of the sample stream. For example, when the initial training phase is done, and blocks 51, 52 and 56 are to be activated, the CPU must know the exact point in the sample stream at which the blocks begin to operate. (Otherwise, the modem software on the CPU will not know when the sample values it receives have changed from time-domain to frequency-domain samples.) Therefore, each data frame transmitted between front-end unit 24 and computer 22 includes a sample count index, preferably a sixteen-bit number, which sequentially counts the transmitted samples. Based on the sample count, CPU 42 and ASIC 100 are able to synchronize their operations on the sample streams to within about 0.5 μs, despite there being no actual connection between the individual clocks of the CPU and ASIC. The sample count is used by controller 122 to determine the exact point in the sample stream at which a given hardware setting in ASIC 100 is to be changed, or to mark the point at which a given event occurred, for reporting to CPU 42.

FIG. 5 is a block diagram that schematically illustrates the software architecture of system 20, in accordance with a preferred embodiment of the present invention. Data samples received by front-end unit 24 are stored in one of receive buffers 108 and are then sent to computer 22 for data pump processing. CPU 42 receives quantities of samples to process that correspond to a predefined time interval, referred to as a programmable time clock (PTC). Typically, a PTC interval corresponds to more data samples than can be carried by a single Ethernet frame. Therefore, a front-end Ethernet driver 133 (or alternatively, processing logic in Ethernet interface unit 36) reads the samples out of the buffer in frame payload quanta 132, so that the Ethernet frames sent over LAN 38 between computer 22 and front-end unit 24 are preferably of fixed size. Driver 133 adds appropriate headers and transmits the data frames over LAN 38. When required to convey control information from controller 122 to CPU 42, driver 133 also generates notification or request frames, which are preferably distinguished by a field in their headers from ordinary data frames.

A PC Ethernet driver 134 is responsible for receiving the data and command frames from LAN 38 and passing the frame payloads to memory 44 of computer 22. A hardware driver abstraction layer 135 then feeds the received samples to a data pump process 136 running on CPU 42. (This layer is also responsible for exchanging control messages with controller 122 in ASIC 100, as noted above.) Data pump process 136 then performs the data pump operations shown in FIG. 2 on the samples, as well as performing the operations shown in FIG. 3 to generate outgoing samples. After processing the incoming samples, the data pump process outputs the recovered data bit stream via framer 66 to communications software 138 running on CPU 42. This software performs conventional modem operations, such as initiating and closing connections. It may also perform upper-layer protocol functions, such as network-layer and transport-layer packet processing, as are known in the art. For example, software 138 may process TCP/IP packets that computer 22 receives from a Web site, via medium 28. The communications software typically passes the packet payloads to an application 140, such as a Web browser running on computer 22.

In a similar fashion, outgoing data generated by application 140 are passed to communications software 138, which typically generates upper-layer protocol headers. Data pump process 136 then modulates the data bits to generate output samples. The samples are conveyed via hardware driver abstraction layer 135 to PC Ethernet driver 134, which decomposes this data into Ethernet frames. These frames are sent over LAN 38 to front-end Ethernet driver 133, which writes the samples to transmit buffer 112 of front-end unit 24.

FIGS. 6A and 6B are timing diagrams that schematically illustrates a method by which system 20 handles a transient disturbance, such as a loss or delay of data frames 132 in transmission over LAN 38, in accordance with a preferred embodiment of the present invention. FIG. 6A shows the case of lost frames, while FIG. 6B shows the case in which frames are significantly delayed. These problems, and the methods shown for dealing with them, apply both to the frames of incoming samples, transmitted from front-end unit 24 to computer 22, and to the frames of outgoing samples, transmitted from the computer to the front-end unit.

Loss and delay of frames are well-known problems in Ethernet LANs, which may occur, for example, due to congestion or transient hardware faults. Data may also be lost due to overflow or underflow of buffers. The loss and significant delay of frames are easily detected, on account of the running sample index carried by each frame. These frames cannot simply be omitted, however, since dropping the frames could be interpreted to indicate the absence of a signal on the modem communication line to or from medium 28, which would cause an immediate disconnect or a time-consuming retrain.

As shown in FIGS. 6A and 6B, computer 22 or front-end unit 24 generates an output sequence 150 of Ethernet frames 132 containing data samples for processing. The frames are identified by their sample indices, marked #n, #n+1, #n+2, . . . In a received sequence 152 at the front-end unit or computer, however, the Ethernet interface notes that two frames 154 have been lost (FIG. 6A) or delayed (FIG. 6B). Therefore, in a corrected sequence 156 of frames whose data is transferred to transmit buffer 112 (in front-end unit 24) or data pump 136 (in computer 22), two random frames 158 are inserted. These frames are preferably based on the previous legal frames, but the sample values that the frames contain do not correspond to any meaningful data. When the “information” in these frames is decoded at the receiving modem, the data will be rejected as erroneous. The normal sequence of frames is resumed when original frames 132 are received at the right timing. The continuity of the connection over medium 28 will have been maintained, however, and connection problems are thus avoided.

Preferably, when there is a loss of synchronization in the sample indices between computer 22 and front-end unit 24, hardware driver 142 of the computer can be used to issue a command, ordering controller 122 to reset the sample count starting in the next frame.

FIG. 7 is a timing diagram that schematically illustrates a method for synchronizing the sampling clock of AFE 30, in accordance with a preferred embodiment of the present invention. As noted above, AFE sampling is typically controlled by a VCXO, which has limited adjustment resolution. In conventional modem configurations, it is possible simply to step the VCXO frequency up and down in real time so that sample timing is approximately correct. In the configuration of system 20, however, timing recovery is controlled remotely, by CPU 42, as illustrated in FIG. 2. Therefore, there is a long and unpredictable delay between issuance of timing commands by CPU 42 and their receipt and implementation by VCXO timing block 104.

In order to overcome this problem, it is desirable that the timing of the VCXO be determined with sufficient accuracy so that the same frequency setting can be held for an extended period. It is costly and impractical to attempt to improve the resolution of the VCXO in an existing AFE. Therefore, in system 20, the scheme shown in FIG. 7 is used instead. This figure shows changes in the frequency setting of the VCXO over time. According to the present embodiment, CPU 42 determines a precise value 160 to which the VCXO should ideally be tuned for an extended period. As shown in the figure, value 160 is in between two actual, adjacent VCXO frequency values: a low value 162 and a high value 164. VCXO timing block 104 drives the VCXO to alternate its frequency between the adjacent values, such that in high-frequency intervals 166, the VCXO frequency is set to high value 164, and in low-frequency intervals 168, the VCXO frequency is set to low value 162. The relative durations of intervals 166 and intervals 168 are set so that the average frequency of the VCXO over time is equal to precise value 160. In the example shown in FIG. 7, value 160 is roughly at one-third of the difference between values 162 and 164, and the ratio of the intervals T₁:T₂ is therefore set to be 1:2.

From time to time, CPU 42 may send commands to controller 122 to change the frequency values or intervals. Typically, AFE 30 also includes a circuit for fine frequency control, subject to the coarse adjustment set by VCXO timing block 104.

It will be appreciated that the preferred embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. Apparatus for data communications, comprising:
at least one modem front end, adapted to receive an incoming communication signal conveying incoming information over a communication medium, and comprising:
front-end circuitry, which is coupled to receive the signal from the communication medium and to process the signal so as to generate a stream of incoming digitized samples; and
a first local area network (LAN) interface unit, which is coupled to receive the incoming digitized samples and to frame the samples in data frames for transmission over a LAN; and at least one modem host, comprising:
a second LAN interface unit, which is adapted to receive the data frames from the LAN and to extract the incoming digitized samples therefrom; and
a sample processor, which is coupled to receive the incoming digitized samples from the second LAN interface unit, and to process the samples so as to extract the information from the signal.

2. Apparatus according to claim 1, wherein the at least one modem front end comprises a plurality of modem front ends, which are coupled to receive signals from respective communication media, and which are coupled to communicate with the at least one modem host over the LAN.

3. Apparatus according to claim 2, wherein the at least one modem host comprises a plurality of modem hosts.

4. Apparatus according to claim 1, wherein the at least one modem host comprises a plurality of modem hosts, which are coupled to communicate with the at least one modem front end over the LAN.

5. Apparatus according to claim 1, wherein the first and second LAN interface units comprise Ethernet interface units.

6. Apparatus according to claim 5, wherein the data frames in which the first LAN interface frames the samples are frames of fixed size, and wherein the first LAN interface is adapted to insert a header in each of the frames.

7. Apparatus according to claim 6, wherein the header comprises a running frame index and a parameter specifying a type of the frame, selected from a group of types consisting of samples, commands and notifications.

8. Apparatus according to claim 7, wherein when the type of the frame is the notification type, the first LAN interface is further adapted to insert at least one parameter in the header, from a group of parameters consisting of a sample counter index, a status response to a command, and an exception notification.

9. Apparatus according to claim 6, wherein the second LAN interface is adapted to send command frames to the first LAN interface unit, each of the command frames comprising a command header including at least one parameter from a group of parameters consisting of a command type, a sample counter index, and a command code.

10. Apparatus according to claim 1, wherein the communication medium comprises a telephone subscriber line.

11. Apparatus according to claim 10, wherein the front-end circuitry is adapted to receive the signal in accordance with an Asymmetric Digital Subscriber Line (ADSL) communication protocol, substantially as defined by standard G992.1 of the International Telecommunications Union.

12. Apparatus according to claim 11, wherein the modem host comprises a computer, and wherein the sample processor comprises a programmable processing unit of the computer, which is programmed in software to process the samples.

13. Apparatus according to claim 1, wherein the modem host comprises a computer, and wherein the sample processor comprises a programmable processing unit of the computer, which is programmed in software to process the samples.

14. Apparatus according to claim 13, wherein the programmable processing unit is further programmed to process the information extracted from the signal using a communication application program.

15. Apparatus according to claim 1, wherein the sample processor is further adapted to operate as a sample generator, which receives outgoing information to be conveyed over the communication medium and processes the outgoing information so as to generate outgoing digital samples, and
wherein the second LAN interface unit is adapted to frame and transmit the outgoing digital samples over the LAN to the first LAN interface unit, and
wherein the front-end circuitry is coupled to receive and process the outgoing digital samples from the first LAN interface unit so as to generate an outgoing communication signal for transmission over the communication medium.

16. Apparatus according to claim 15, wherein the front-end circuitry is adapted to generate the outgoing communication signal substantially continuously, notwithstanding a transient disturbance in receiving the outgoing digital samples from the sample processor.

17. Apparatus according to claim 16, wherein the second LAN interface unit is adapted to add an index to the outgoing digital samples transmitted over the LAN indicative of a running count of the samples, and wherein the at least one modem front end is adapted to detect the transient disturbance responsive to the index, and to generate substitute samples for processing so as to compensate for the loss.

18. Apparatus according to claim 17, wherein the disturbance in the transmission comprises a loss of one or more of the data frames.

19. Apparatus according to claim 17, wherein the disturbance in the transmission comprises a delay in arrival of one or more of the data frames at the modem front end.

20. Apparatus according to claim 17, wherein the sample processor is adapted to generate a command to alter an operating parameter of the front-end circuitry at a point in time corresponding to a predetermined value of the running count of the samples, and
wherein the second LAN interface unit is adapted to send a command frame to the first LAN interface unit containing the command, which causes the front-end circuitry to alter the operating parameter when the running count reaches the predetermined value.

21. Apparatus according to claim 1, wherein the front-end circuitry comprises:
an analog front end, which is coupled to receive the signal in analog form, and to digitize the signal so as to generate raw digital samples; and
digital preprocessing circuitry, which is adapted to performing one or more initial processing steps required to extract the information from the signal, whereby the stream of digitized samples conveyed to the sample processor comprises preprocessed samples, and
wherein the sample processor is adapted to perform one or more subsequent processing steps on the preprocessed samples.

22. Apparatus according to claim 21, wherein the one or more initial processing steps comprise a time-to-frequency transformation step, so that the preprocessed samples comprise frequency-domain samples.

23. Apparatus according to claim 21, wherein the one or more initial processing steps comprise an equalization step.

24. Apparatus according to claim 21, wherein the one or more initial processing steps comprise an echo cancellation step.

25. Apparatus according to claim 21, wherein the digital preprocessing circuitry is configurable, under control of the sample processor, to bypass at least one of the initial processing steps, whereupon the sample processor itself performs the at least one of the initial steps that is bypassed.

26. Apparatus according to claim 25, wherein the incoming communication signal is received via a connection over the communication medium with a remote modem,
wherein during an initial phase of the connection, the digital preprocessing circuitry is configured so that the at least one of the initial processing steps is bypassed and performed by the sample processor, and
wherein during a subsequent phase of the connection, following the initial phase, the digital preprocessing circuitry is reconfigured so that the at least one of the initial processing steps is no longer bypassed, whereby the digital preprocessing circuitry performs the at least one of the initial processing steps.

27. Apparatus according to claim 26, wherein the initial phase comprises a training phase, during which parameters of the connection are determined by negotiation between the sample processor and the remote modem, and wherein the parameters are set in the digital preprocessing circuitry during the subsequent phase.

28. Apparatus according to claim 25, wherein the digital preprocessing circuitry is configurable so that each of the initial processing steps can be activated or deactivated under control of the sample processor.

29. Apparatus according to claim 25, wherein the sample processor is adapted to control the digital preprocessing circuitry so as to activate the initial processing steps in sequence.

30. Apparatus according to claim 1, wherein the front-end circuitry comprises a local oscillator, which is adapted to generate a sampling clock for use in sampling the signal so as to generate the digitized samples, and
wherein the sample processor is adapted, responsive to the incoming digitized samples, to determine a desired frequency of the sampling clock, and
wherein the second LAN interface unit is adapted to send a command frame to the first LAN interface unit indicating the desired frequency determined by the sample processor, causing the front-end circuitry to adjust the local oscillator responsive to the desired frequency.

31. Apparatus according to claim 30, wherein the local oscillator is configured to generate the sampling clock at a set of discrete operating frequencies, and
wherein the front-end circuitry comprises an oscillator controller, which is adapted to control the local oscillator so as to select the operating frequencies, and
wherein when the desired frequency is between two of the discrete operating frequencies, the oscillator controller controls the local oscillator so that it generates the sampling clock at the two of the discrete operating frequencies in respective, alternating time intervals.

32. Apparatus according to claim 31, wherein the alternating time intervals have durations selected so that an average operating frequency of the sampling clock over the intervals is approximately equal to the desired frequency.

33. Apparatus according to claim 1, wherein the first LAN interface unit is adapted to add an index to each of the data frames indicative of a running count of the samples transmitted over the LAN, and wherein the sample processor is adapted to synchronize its operation with that of the modem front end responsive to the index.

34. Apparatus according to claim 33, wherein the sample processor is adapted to detect a disturbance in transmission of the data frames responsive to the index, and to generate substitute samples for processing so as to compensate for the disturbance.

35. Apparatus according to claim 34, wherein the disturbance in the transmission comprises a loss of one or more of the data frames.

36. Apparatus according to claim 34, wherein the disturbance in the transmission comprises a delay in arrival of one or more of the data frames at the sample processor.

37. Apparatus according to claim 33, wherein the sample processor is adapted to generate a command to alter an operating parameter of the front-end circuitry at a point in time corresponding to a predetermined value of the running count of the samples, and
wherein the second LAN interface unit is adapted to send a command frame to the first LAN interface unit containing the command, which causes the front-end circuitry to alter the operating parameter when the running count reaches the predetermined value.

38. Apparatus for data communications, comprising:
a modem host, comprising:
a sample generator, which is adapted to receive information for transmission over a communication medium and to generate, responsive to the information, a stream of outgoing digital sample values;
a first local area network (LAN) interface unit, which is coupled to receive the outgoing digital sample values and to frame the values in data frames for transmission over a LAN; and a modem front end, comprising:
a second LAN interface unit, which is adapted to receive the data frames from the LAN and to extract the outgoing digital sample values therefrom; and
front-end circuitry, which is coupled to receive the outgoing digital sample values and to process the values so as to generate an outgoing signal for transmission over the public communication network.

39. A method for data communications, comprising:
receiving an incoming communication signal conveying incoming information over a communication medium;
sampling and processing the incoming signal so as to generate a stream of incoming digitized samples;
framing the incoming digitized samples in data frames for transmission over a local area network (LAN);
transmitting the data frames over the LAN to a processing unit;
extracting the samples from the frames at the processing unit;
processing the samples, using the processing unit, so as to extract the information from the signal.

40. A method according to claim 39, wherein transmitting the data frames comprises selecting one of a plurality of processing units to process the samples, and transmitting the frames to the selected one of the processing units.

41. A method according to claim 39, wherein receiving the incoming communication signal comprises receiving the signal at one of a plurality of front-end units that are connected to communicate over the LAN.

42. A method according to claim 39, wherein transmitting the data frames comprises transmitting the frames over an Ethernet LAN.

43. A method according to claim 42, wherein transmitting the frames comprises framing the samples so that the frames are of substantially fixed size, and inserting a header in each of the frames.

44. A method according to claim 43, wherein the header comprises a running frame index and a parameter specifying a type of the frame, selected from a group of types consisting of samples, commands and notifications.

45. A method according to claim 44, wherein when the type of the frame is the notification type, inserting the header comprises inserting at least one parameter in the header, from a group of parameters consisting of a sample counter index, a status response to a command, and an exception notification.

46. A method according to claim 43, and comprising sending command frames from the processing unit over the LAN to a modem front end that receives and samples the signal, each of the command frames comprising a command header including at least one parameter from a group of parameters consisting of a command type, a sample counter index, and a command code.

47. A method according to claim 39, wherein receiving the incoming communication signal comprises receiving the signal over a telephone subscriber line.

48. A method according to claim 47, wherein receiving the signal comprises receiving the signal in accordance with an Asymmetric Digital Subscriber Line (ADSL) communication protocol, substantially as defined by standard G992.1 of the International Telecommunications Union.

49. A method according to claim 39, wherein processing the samples comprises processing the samples using a programmable processing unit of a computer, which is programmed in software to process the samples.

50. A method according to claim 49, and comprising processing the information extracted from the signal using a communication application program running on the computer.

51. A method according to claim 39, wherein the incoming signal is received, sampled and processed by a modem front end, and wherein the method comprises:
receiving outgoing information to be conveyed over the communication medium; processing the outgoing information so as to generate outgoing digital samples;
framing and transmitting the outgoing digital samples over the LAN to the modem front end; and
receiving and processing the outgoing digital samples received at the modem front end from the LAN so as to generate an outgoing communication signal for transmission over the communication medium.

52. A method according to claim 51, wherein processing the outgoing digital samples at the modem front end comprises generating the outgoing communication signal substantially continuously, notwithstanding a transient disturbance in receiving the outgoing digital samples from the sample processor.

53. A method according to claim 52, wherein framing and transmitting the outgoing digital samples comprises adding an index to the outgoing digital samples transmitted over the LAN indicative of a running count of the samples, and wherein generating the outgoing communication signal comprises detecting the transient disturbance at the modem front end responsive to the index, and generating substitute samples for processing so as to compensate for the loss.

54. A method according to claim 53, wherein detecting the transient disturbance comprises detecting a loss of one or more of the data frames.

55. A method according to claim 53, wherein detecting the disturbance in the transmission comprises detecting a delay in arrival of one or more of the data frames at the modem front end.

56. A method according to claim 39, wherein sampling and processing the incoming signal comprises:
digitizing the signal so as to generate raw digital samples; and
performing on the raw digital samples at a modem front end one or more initial digital processing steps required to extract the information from the signal, whereby the incoming digitized samples comprise preprocessed samples,
wherein processing the samples comprises performing one or more subsequent processing steps on the preprocessed samples.

57. A method according to claim 56, wherein performing the one or more initial processing steps comprises performing a time-to-frequency transformation step, so that the preprocessed samples comprise frequency-domain samples.

58. A method according to claim 56, wherein performing the one or more initial processing steps comprises performing an equalization step.

59. A method according to claim 56, wherein performing the one or more initial processing steps comprises performing an echo cancellation step.

60. A method according to claim 56, wherein sampling and processing the incoming signal comprises bypassing at least one of the initial digital processing steps in the modem front end, under control of the sample processor, whereupon processing the samples comprises performing, using the processing unit, the at least one of the initial steps that is bypassed.

61. A method according to claim 60, wherein receiving the incoming communication signal comprises receiving the signal via a connection over the communication medium with a remote modem, and
wherein bypassing the at least one of the initial digital processing steps comprises configuring the modem front end to bypass the at least one of the steps during an initial phase of the connection, so that the at least one of the initial processing steps is performed by the processing unit, and comprising, during a subsequent phase of the connection, following the initial phase, reconfiguring the modem front end so that the at least one of the initial processing steps is no longer bypassed, whereby the modem front end performs the at least one of the initial processing steps.

62. A method according to claim 61, wherein the initial phase comprises a training phase, during which parameters of the connection are determined by negotiation between the sample processor and the remote modem, and wherein the parameters are implemented in the modem front end during the subsequent phase.

63. A method according to claim 61, wherein reconfiguring the modem front end comprises activating the initial processing steps in the modem front end in sequence.

64. A method according to claim 60, wherein the modem front end is configured so that each of the initial processing steps can be activated or deactivated under control of the sample processor, and wherein bypassing the at least one of the initial digital processing steps comprises selecting one or more of the steps to bypass using the sample processor.

65. A method according to claim 39, wherein sampling the incoming signal comprises generating a sampling clock in a modem front end, and sampling the signal in the modem front end responsive to the clock so as to generate the digitized samples, and wherein the method further comprises:
determining at the processing unit, responsive to the incoming digitized samples, a desired frequency of the sampling clock;
sending a command frame from the processing unit over the LAN to the modem front end indicating the desired frequency; and
adjusting the sampling clock at the modem front end responsive to the desired frequency indicated by the command frame.

66. A method according to claim 65, wherein generating the sampling clock comprises generating the clock at a set of discrete operating frequencies, and when the desired frequency is between two of the discrete operating frequencies, switching the sampling clock between the two of the discrete operating frequencies in respective, alternating time intervals.

67. A method according to claim 66, wherein switching the sampling clock comprises setting durations of the alternating time intervals so that an average operating frequency of the sampling clock over the intervals is approximately equal to the desired frequency.

68. A method according to claim 39, wherein framing the incoming digitized samples comprises adding an index to each of the data frames indicative of a running count of the samples transmitted over the LAN, and wherein processing the samples comprises synchronizing the processing of the samples responsive to the index.

69. A method according to claim 68, and comprising detecting an event associated with the incoming communication signal, and reporting the event to the processing unit along with the index to identify a time at which the event occurred.

70. A method according to claim 68, wherein synchronizing the processing of the samples comprises:
detecting a disturbance in transmission of the data frames responsive to the index; and
generating substitute samples for processing so as to compensate for the disturbance.

71. A method according to claim 70, wherein detecting the disturbance in the transmission comprises detecting a loss of one or more of the data frames.

72. A method according to claim 70, wherein detecting the disturbance in the transmission comprises detecting a delay in arrival of one or more of the data frames at the sample processor.

73. A method according to claim 68, wherein sampling and processing the incoming signal comprises sampling and processing the signal in a modem front end, and comprising:
generating a command to alter an operating parameter of the front end at a point in time corresponding to a predetermined value of the running count of the samples; and
sending a command frame containing the command over the LAN from the processing unit to the front end, which causes the front end to alter the operating parameter when the running count reaches the predetermined value.

74. A method for data communications, comprising:
receiving outgoing information for transmission over a communication medium; generating, responsive to the information, a stream of outgoing digital sample values;
framing the outgoing digital sample values in data frames for transmission over a local area network (LAN);
transmitting the data frames over the LAN to a modem front end;
extracting the sample values from the frames at the modem front end;
processing the sample values at the modem front end so as to generate an outgoing signal for transmission over the public communication network.

75. A front end unit for a modem, comprising:
front-end circuitry, which is adapted to receive an incoming communication signal conveying incoming information over a communication medium, and to process the signal so as to generate a stream of incoming digitized samples; and
a local area network (LAN) interface unit, which is coupled to receive the incoming digitized samples and to frame the samples in incoming data frames for transmission over a LAN to a modem host for processing of the samples so as to extract the information from the signal.

76. A front end unit according to claim 75, wherein the LAN interface unit is further adapted to receive outgoing data frames transmitted over the LAN by the modem host, the outgoing data frames containing outgoing digital samples, and
wherein the front-end circuitry is adapted to receive and process the outgoing digital samples from the LAN interface unit so as to generate an outgoing communication signal for transmission over the communication medium.

77. A computer software product, comprising a computer-readable medium in which program instructions are stored, which instructions, when executed by a computer, cause the computer to receive data frames from a LAN, the data frames containing incoming digitized samples generated by a modem front end responsive to an incoming communication signal conveying incoming information received by the modem front end over a communication channel, and further cause the computer to extract the incoming digitized samples from the data frames, and to process the samples so as to extract the information from the signal.

78. A product according to claim 77, wherein the instructions further cause the computer to generate outgoing digital sample values responsive to outgoing information to be conveyed by the computer over the communication channel, and to frame and transmit the outgoing digital sample values over the LAN to the modem front end, causing the modem front end to generate, responsive to the outgoing digital sample values an outgoing communication signal for transmission over the communication channel.
